(19) United States
(12) Patent Application Publication
(10) Pub. No.: US 2026/0154102 A1
(43) Pub. Date: Jun. 4, 2026

(54) QUERY PROCESSOR ALLOCATOR

(71) Applicant: Amazon Technologies, Inc., Seattle, WA (US)

(72) Inventors: Marc Bowes, Seattle, WA (US); Marc Brooker, Seattle, WA (US); Taylor Neely, Seattle, WA (US); Brett McChesney, Bozeman, MT (US); James Alexander Morle, Dripping Springs, TX (US); Brandon Pike, Frisco, TX (US)

(73) Assignee: Amazon Technologies, Inc., Seattle, WA (US)

(21) Appl. No.: 18/980,880

(22) Filed: Dec. 13, 2024

Related U.S. Application Data
(60) Provisional application No. 63/727,102, filed on Dec. 2, 2024.

(51) Int. Cl. G06F 9/46; G06F 16/2455; G06F 16/27

(52) U.S. Cl. CPC G06F 9/466; G06F 16/2455; G06F 16/27

(57) ABSTRACT

A database system may virtualize client connections to query processors to enable the query processors to be used by active connections rather than allowing the query processors to remain idle. Virtualizing the client connections may enable the database system and other systems sharing computing resources with the database system to operate with increased efficiency over a database system which does not virtualize client connections.

### PRIORITY CLAIM

This application claims benefit of priority to U.S. Provisional Application Ser. No. 63/727,102, entitled “QUERY PROCESSOR ALLOCATOR,” filed Dec. 2, 2024, and which is hereby incorporated herein by reference in its entirety.

### BACKGROUND

Database systems may use query processors to process transactions at databases for clients. Clients may open connections to query processors in order to interact with a database, for example, by performing reads and writes to the database. A connection between a client and a query processor may be idle while the client is not interacting with the database, and the query processor may be unable to be used by another client or for another purpose while the connection is idle.

### BRIEF DESCRIPTION OF THE DRAWINGS

FIG. 1 is a block diagram illustrating a database service which uses a transaction execution manager and processor allocators for distributing client connections and database transactions, according to some embodiments.

FIG. 2A is a block diagram illustrating relationships between processor allocators and query processors, according to some embodiments.

FIG. 2B is a block diagram illustrating relationships between processor allocators and various groupings of query processors, according to some embodiments.

FIG. 3A is a block diagram illustrating action of a transaction execution manager upon receiving connection requests from a client, according to some embodiments.

FIG. 3B is a block diagram illustrating action of a transaction manager upon receiving a request to process a transaction, according to some embodiments.

FIG. 4 is a flowchart for a process for a virtualized database system to allocate and manage query processors for processing transactions, according to some embodiments.

FIG. 5 is a flowchart for a process for a virtualized database system to associate host computing devices with a particular cluster, according to some embodiments.

FIG. 6A is a block diagram illustrating a query processor to storage network arranged as a complete bipartite graph (e.g., biclique), according to some embodiments.

FIG. 6B is a block diagram illustrating virtual machine servers that implement query processors of a distributed database at a first time, such as before a cluster closes the query processor instances of the cluster, and also illustrating the virtual machine servers at a second time, such as after the cluster closes the query processor instances of the cluster, according to some embodiments.

FIG. 7 is a block diagram illustrating various components of a database service and storage service that host a distributed database, according to some embodiments.

FIG. 8 is a block diagram illustrating a provider network that may implement database services that implement techniques described herein, according to some embodiments.

FIG. 9 is a block diagram illustrating an example computer system that implements some, or all, of the techniques described herein, according to some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as described by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

### DETAILED DESCRIPTION

A database system may include query processors, which clients may connect to in order to executes reads and writes on a database. While a query processor is assigned to a connection, the query processor may be unable to process queries for other clients or other databases. The database system may assign the connection to a processor allocator, which may forward transactions to be processed to query processors. The query processors themselves may not be assigned to a connection, and may be available for use in processing transactions for various clients or databases.

When a client contacts the database system, the client may have an estimate of an amount of processing power necessary to interact with the database during high-volume transaction events, such as a period of time with a known amount of reads or writes which the database system may need to execute. The client may request a number of connections based on the expected high-volume transaction events, which may be called spikes. The database system may select a set of host computing devices to associate with a cluster. A cluster may designate elements of the database system which are meant to interact with a particular database or set of databases, such as databases of the client. The number of selected host computing devices may be based on the requested number of connections, such that in the event all requested connections are in simultaneous actual use each of the selected computing devices uses a threshold number of query processors.

At an individual host computing device, there may be a plurality of physical processors, such as a CPU, which are able to be configured to be query processors. A physical processor may be configured to be a query processor by being associated with an amount of memory which stores at least program instructions for how to process transactions, such as reads or writes, for a database. In some embodiments the physical processors may be part of a system that is used for providing virtual machines. Query processors may be virtual machines implemented using the physical processors, and a single physical processor may implement more than one query processor. Query processors may also be called query processor instances. “Processors” as used herein refers to query processors, which may be implemented using physical processors as part of a virtual machine service.

A host computing device may include a plurality of processor allocators and a plurality of query processors. A processor allocator may be associated with a cluster, i.e., able to interact with other distributed elements of a database of the cluster, for example by having appropriate credentials or encryption information. The processor allocator may receive a transaction to be processed and select a query processor of the host computing device to process the transaction. The query processor may have already been associated with the cluster, or may be associated with the cluster as a result of being selected by the processor allocator. The query processor may remain associated with the cluster after processing the transaction. The query processor may be unassociated with the cluster based on a threshold, such as a threshold period of time since the query processor was active, a threshold period of time since the processor allocator received a transaction to be processed, a threshold amount of idle processors associated with the cluster, a threshold amount of idle processors in the host computing device, or a dynamic threshold based on the likelihood a transaction for the cluster will arrive and the likelihood a transaction for a different cluster will arrive.

A query processor may be released by releasing the program instructions for how to process transactions from the memory associated with the query processor. A query processor may be associated with a cluster until the query processor is released. Memory associated with a query processor may include information about the cluster associated with the query processor, for example credentials or encryption information for interacting with other distributed elements of the database or databases associated with the cluster. The information about the cluster which is stored in memory may be difficult to separate from program instructions for how to process transactions, for example, so a database system using query processor allocation may release a query processor rather than use the query processor to process transactions for multiple clusters. A processor allocator may maintain state information for a cluster, for example, connection information associated with the connections assigned to the particular computing device the processor allocator is associated with and cluster information such as encryption information associated with the cluster. A query processor, when assigned to a cluster, may receive the cluster information from the processor allocator. Connections assigned to a particular processor allocator may be reassigned to another processor allocator of the cluster, for example a processor allocator associated with another computing device, by transferring the connection information from the particular processor allocator to the other processor allocator.

A processor allocator may manage active transactions for a cluster by selecting query processors to process the transactions and by providing the query processors with information about the cluster, for example cluster identification information for locating other elements of the distributed database the query processors may interact with and state information such as client preferences regarding data or temporary tables. Query processors may obtain the state information from the processor allocator for use and may update the state information maintained in the processor allocator.

One or more of the embodiments described herein may be capable of achieving one or more of the following technical advantages. Embodiments may improve the efficiency of a database system and by reducing the amount of time that query processors remain idle. Embodiments may improve the efficiency of virtual machine systems which are used for database systems by reducing the amount of computing resources required for operating the database system.

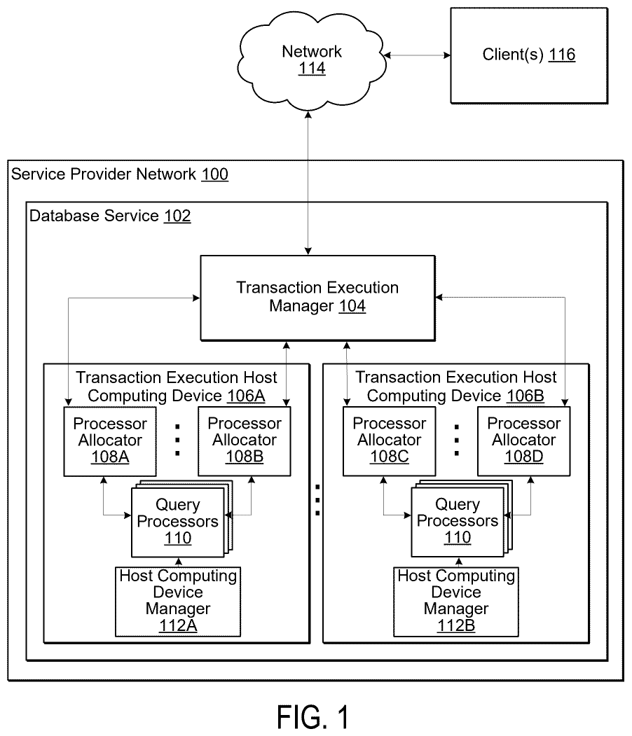

FIG. 1 is a block diagram illustrating a database service which uses a transaction execution manager and processor allocators for distributing client connections and database transactions, according to some embodiments.

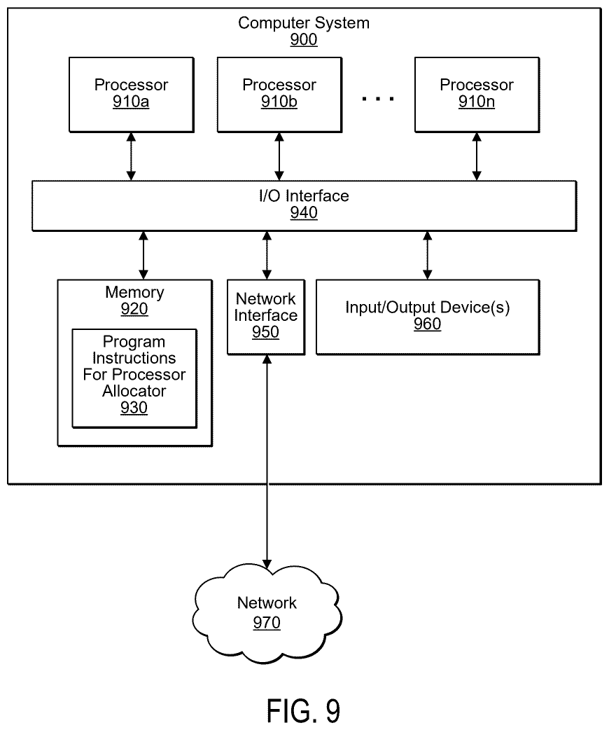

A service provider network 100 may use computing devices, such as computer system 900 illustrated in FIG. 9, to provide services such as database service 102. Database service 102 may enable clients 116 to create and interact with databases. Clients 116 may interact with service provider network 100 via an external network 114 such as the Internet, and clients 116 may be internal to the service provider network 100.

Clients 116 may send requests for connections between the clients 116 and the database service 102 and requests to process transactions to a transaction execution manager 104. The transaction execution manager 104 may determine which transaction execution host computing device 106 to associate client connections with and which transaction execution host computing device 106 to forward transactions to. Both determinations may be based on consistent hashing or another selection method over a limited set of transaction execution host computing devices 106 and may also be based on the capacity of the transaction execution host computing devices 106. The limited set of transaction execution host computing devices 106 may be based on a number of connections of the cluster and a maximum number of allowed connections per cluster per transaction execution host computing device 106, i.e., the limited set of transaction execution host computing devices 106 may have a number of transaction execution host computing devices 106 equal to the number of connections of the cluster divided by the maximum number of allowed connections per cluster per transaction execution host computing device 106.

The transaction execution manager 104 may associate a number of client connections that is or is less than a maximum number of allowed connections per cluster per transaction execution host computing device 106 with any given transaction execution host computing device 106. The total number of connections per transaction execution host computing device 106 may exceed a number of query processors 110 per transaction execution host computing device 106. For example, transaction execution host computing device 106A may have two processor allocators 108, i.e., processor allocator 108A and processor allocator 108B, so the transaction execution host computing device 106A may be associated with two clusters. The transaction execution host computing device 106A may have ten query processors 110 to allocate between the two associated clusters. The maximum allowed number of connections per cluster per transaction execution host computing device 106 may be eight. The maximum allowed number of connections per cluster per transaction execution host computing device 106 may be selected based on a maximum estimated amount of transaction volume, i.e., when the cluster of processor allocator 108A is operating at capacity, the cluster of processor allocator 108B is expected to be operating below capacity. In the example, a cluster associated with more than eight connections may be associated with multiple transaction execution host computing devices 106. At any given time, each connection may be associated with one or fewer transactions which are actively being processed by a query processor, depending on the amount of transactions the client actually requests to be processed using the requested connections at the given time.

A host computing device manager 112A may manage virtual machines which are not configured to be query processors and query processors 110 which are not associated with a particular database cluster. For example, the host computing device manager 112A may instantiate a query processor configuration on a virtual machine not configured to be a query processor to configure the virtual machine to be a query processor 110 that a processor allocator 108 may select to associate with the cluster of the processor allocator 108 and process transactions for the cluster. As another example, the host computing device manager 112A may enable virtual machines nor configured to be query processors to be used for other virtual machine functions.

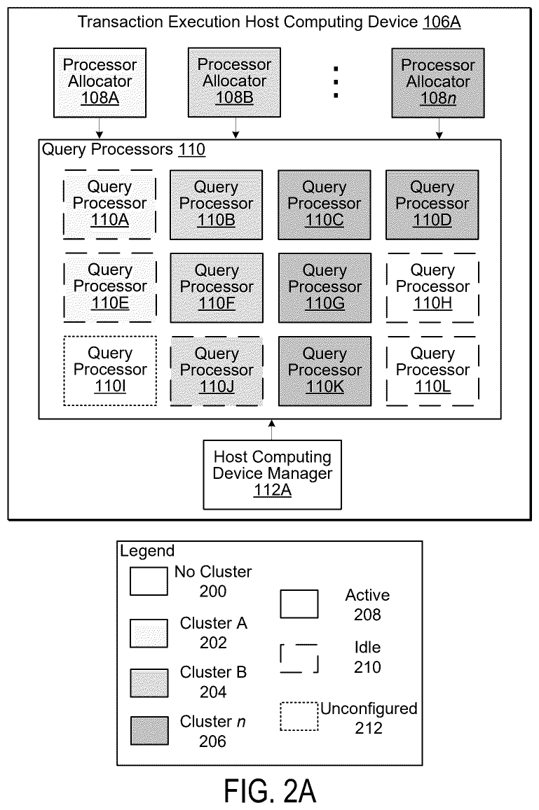

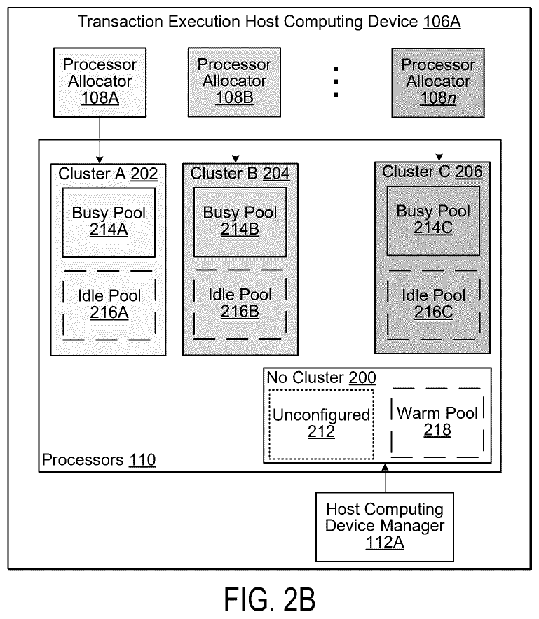

FIG. 2A is a block diagram illustrating relationships between processor allocators and query processors, according to some embodiments.

Query processors 110 may be active 208, meaning that the query processor 110 is configured to process transactions and is presently processing a transaction, or idle 210, meaning that the query processor 110 is configured to process transactions and is not presently processing a transaction. A host computing device manager 112A may cause an unconfigured 212 virtual machine (110I) to become an idle 210 query processor 110 that is not associated with a cluster 200 (110H or 110L) by loading program instructions for how to process transactions to the unconfigured 212 virtual machine (110I). The host computing device manager 112A may also cause unconfigured 212 virtual machines to perform computing tasks other than transaction processing.

The processor allocators 108 and query processors 110 may be associated with clusters. Each cluster may be associated with a database or set of databases which have been designated as a cluster by a client. In FIG. 2A, processor allocator 108A is associated with cluster A 202, and has allocated query processor 110A and query processor 110E to cluster A 202. Both query processor 110A and query processor 110E are idle 210, so cluster A 202 is not processing transactions on transaction execution host computing device 106A. Query processor 110A and query processor 110E may remain associated with cluster A 202 until a threshold is reached, for example, the threshold may be an amount of time since query processor 110A and query processor 110E have processed transactions, the threshold may be based on the total number of idle 210 query processors 110 for the transaction execution host computing device 106A, and the threshold may be based on the likelihood that a cluster A 202 transaction will be requested compared to a current workload other than for cluster A 202. The processor allocator 108A may determine whether the threshold has been reached to release an idle 210 query processor 110.

Three query processors 110 are associated with cluster B 204. Query processor 110B and query processor 110F are active 208, meaning that both are presently processing a transaction. A new transaction for cluster B 204 would be processed by the idle 210 query processor 110J. Processor allocator 108B may determine whether a threshold for releasing query processor 110J has been reached. The four query processors (110C, 110D, 110G, and 110K) associated with cluster n 206 are all active 208, meaning that all four are presently processing a transaction. Processor allocator 108n may allocate an idle 210 query processor that is not associated with a cluster 200 to cluster n in respond to a new transaction arriving for cluster n 206 before one of the four query processors (110C, 110D, 110G, and 110K) associated with cluster n 206 finish processing a transaction and become idle 210.

Host computing device manager 112A may determine whether the amount of available idle 210 query processors with no cluster (110H and 11L) is sufficient based on the workload of clusters at capacity, i.e., with no associated idle 210 query processors 110, such as cluster n 206. The host computing device manager 112A may configure previously unconfigured 212 virtual machines into idle 210 query processors with no cluster 200 based on a determination that the workload of a cluster without associated idle 210 query processors 110 may increase.

Although the transaction execution host computing device 106A may have a maximum number of allowed connections per cluster, the actual number of query processors 110 allocated to a given cluster at any one time may exceed that number.

FIG. 2B is a block diagram illustrating relationships between processor allocators and various groupings of query processors, according to some embodiments.

Each cluster that has an associated processor allocator 108 on a transaction execution host computing device 106A may have a busy pool 214 of query processors 110 which are active 208, i.e., presently processing transactions, and an idle pool 216 of query processors 110 which are idle 210, i.e., not presently processing transactions. An individual query processor 110 may switch between belonging to a busy pool 214 and an idle pool 216, and may remain associated with a single cluster. A host computing device manager 112A may manage unconfigured 212 virtual machines and a warm pool 218 of idle query processors that are not associated with a cluster 200.

A processor allocator 108A may select a query processor 110 from the warm pool 218 to process a transaction for the cluster, such as cluster A 202, which is associated with the processor allocator 108A. While the query processor 110 is processing the transaction, the query processor 110 is part of the busy pool 214A for the cluster, such as cluster A 202. When the query processor 110 finishes processing the transaction, the query processor 110 becomes part of the idle pool 216A for the cluster, such as cluster A 202, to await additional transactions to process. The processor allocator 108A may release the query processor 110 from the idle pool 216A, for example based on a threshold amount of query processors 110 being associated with the cluster, such as cluster A 202. The threshold amount of query processors 110 may be an average or an expected amount of query processors 110 for the particular cluster. Another example of a threshold a processor allocator 108 may use is a time based threshold, such as a period of time since the query processor 110 joined the idle pool 216. The processor allocator 108A may select query processors 110 from the idle pool 216 which most recently joined the idle pool 216 from the busy pool 214 to process incoming transactions so that the number of query processors 110 the idle pool 216 may not be kept artificially above an approximate amount of query processors 110 that the cluster uses. In some embodiments, a release event other than a threshold, such as a request to release idle query processors 110 by a management entity, may trigger a processor allocator 108 to release idle query processors 110.

When released, the query processor 110 may cease to be a query processor 110 because the underlying virtual machine is not configured 212 to be a query processor 110. The unconfigured virtual machine 212 may not be associated with a cluster 200. In some embodiments, the query processor 110, when released, may remain configured to be a query processor 110 but may be unassociated with a cluster 200. The host computing device manager 112A may instantiate a query processor virtual machine onto the unconfigured virtual machine 212 to cause the unconfigured virtual machine 212 to become a query processor 110 which does not have a cluster 200, and is part of the warm pool 218. The query processor 110 in the warm pool 218 may then be selected by a processor allocator 108B to process a transaction for the cluster, such as cluster B 204, of the processor allocator 108B and be a part of the corresponding busy pool 214B.

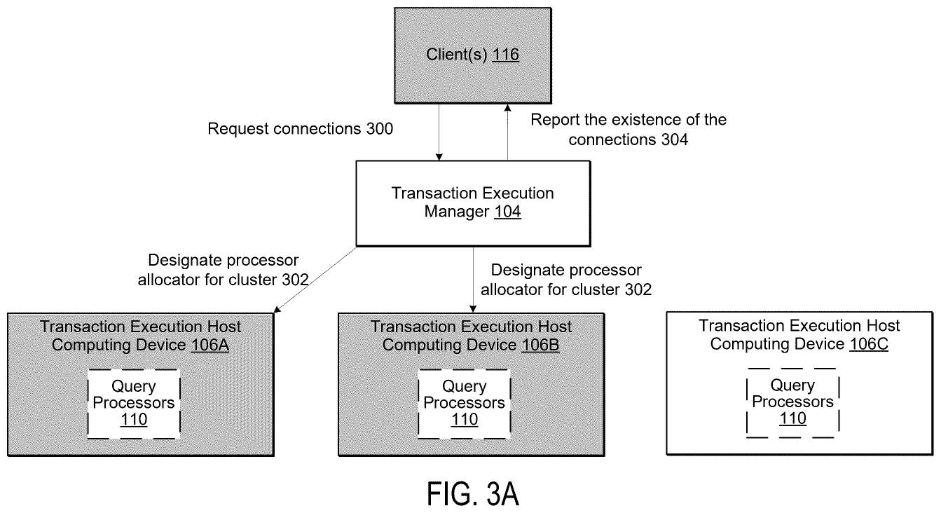

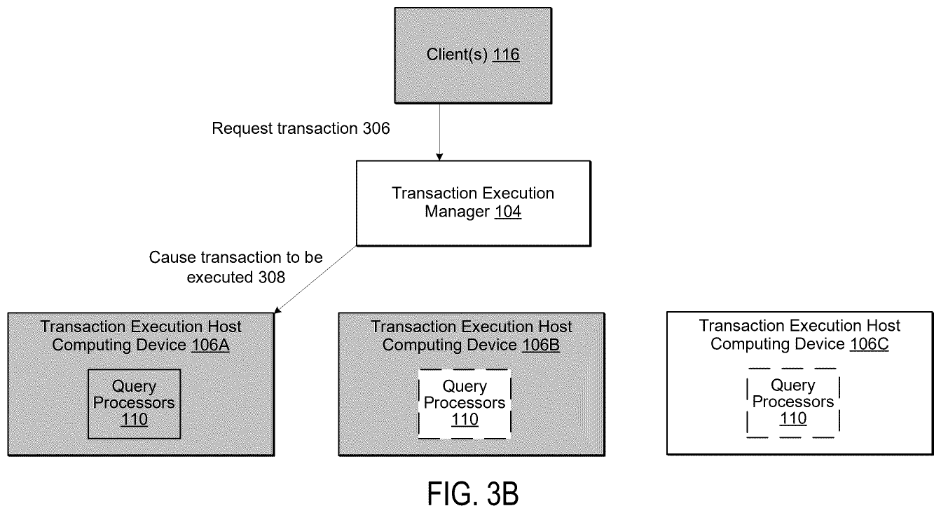

FIG. 3A is a block diagram illustrating action of a transaction execution manager upon receiving connection requests from a client, according to some embodiments.

At 300, a client 116 requests connections to the database system via transaction execution manager 104. At 302, the transaction execution manager 104 designates a processor allocator at some of the transaction execution host computing devices 106 to the cluster 206 associated with the databases of the client 116. At 304 the transaction execution manager 104 reports the existence of the requested connections to the client 116. The available query processors 110 of the transaction execution host computing devices 106 may remain unassociated with the cluster 200, and may remain idle 210. The connections may be made to the processor allocator of the transaction execution host computing device 106 that is associated with the cluster 206. The processor allocator may store information about the connections as state information, and the connections may be moved to another transaction execution host computing device 106C, for example, by transferring the state information about the connections to a processor allocator on the other transaction execution host computing device 106C.

FIG. 3B is a block diagram illustrating action of a transaction manager upon receiving a request to process a transaction, according to some embodiments.

At 306, the client 116 requests one or more transactions be processed for the database cluster. At 308, the transaction execution manager 104 causes a transaction to be executed by forwarding the transaction to a processor allocator associated with the cluster 206. The processor allocator selects a query processor 110 of the processor allocator's transaction execution host computing device 106A to process the transaction. The query processor 110 is associated with the database cluster 206 either before the query processor was selected or as a result of the query processor 110 being selected. While the query processor 110 is processing the transaction, the query processor 110 is active 208.

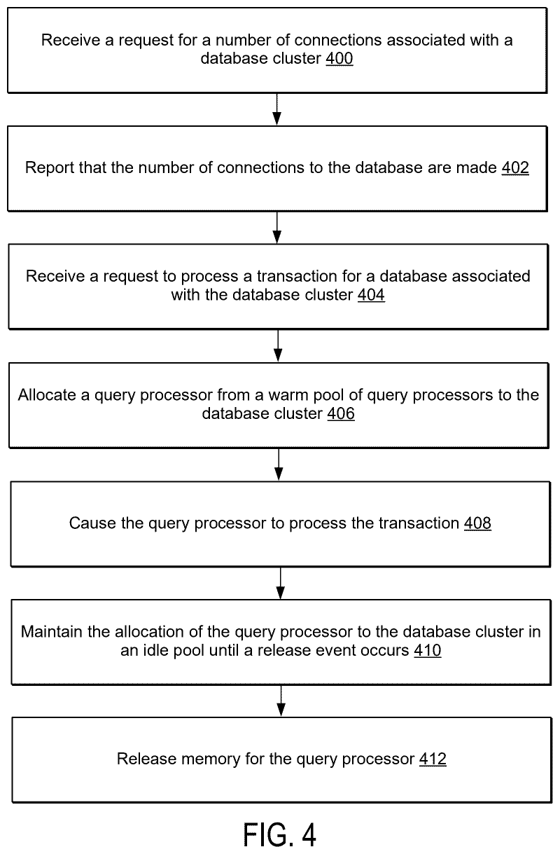

FIG. 4 is a flowchart for a process for a virtualized database system to allocate and manage query processors for processing transactions, according to some embodiments.

At 400, a processor allocator receives a request for a number of connections associated with a database cluster. The number of requested connections may be a maximum allowed number of connections for a particular host computing device. At 402, the processor allocator reports that the number of connections to the database are made. At 404, the processor allocator receives a request to process a transaction for a database associated with the database cluster. At 406, the processor allocator selects a query processor from a warm pool or idle pool of query processors to process the transaction. A query processor from a warm pool of query processors may be unassociated with any cluster until a processor allocator selects the query processor, which causes the query processor to be associated with the cluster of the processor allocator. A query processor from an idle pool of query processors may already be associated with the cluster of the processor allocator.

At 408, the processor allocator causes the query processor to process the transaction. While the query processor is processing the transaction, the query processor may be in a busy or active pool of query processors. After the transaction is processed, at 410 the processor allocator maintains the allocation of the query processor to the database cluster in an idle pool until a release event occurs. The release event may be a threshold being met, for example, a time-based threshold, a query processor-based threshold, or another type of threshold. For example, the threshold may be a time period after the query processor completes the transaction. As another example, the threshold may be a number of query processors in the idle pool associated with the processor allocator. As another example, the threshold may be an amount of total memory free for the host computing device. Another example of a release event may be an instruction from a management entity to release the memory for the query processor. At 412, the processor allocator may release memory for the query processor, which may cause the query processor to cease being a query processor and cease being associated with the database cluster. In some embodiments, when the memory for the query processor is released, the query processor remains configured to be a query processor and ceases to be associated with the database cluster.

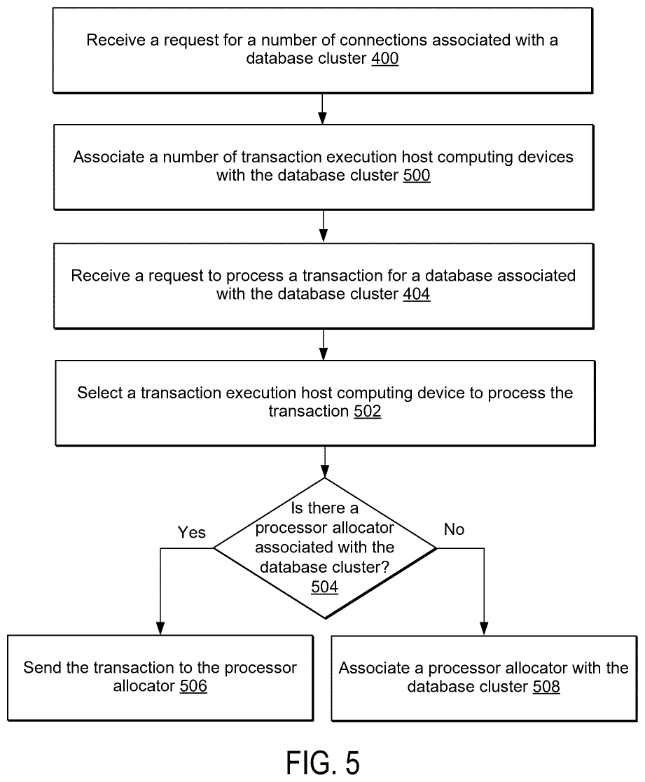

FIG. 5 is a flowchart for a process for a virtualized database system to associate host computing devices with a particular cluster, according to some embodiments.

At 400, a transaction execution manager receives a request for a number of connections associated with a database cluster. At 500, the transaction execution manager associates a number of transaction execution host computing devices with the database cluster. In some embodiments, the transaction execution manager may associate transaction execution host computing devices with a cluster by designating a processor allocator associated with each transaction execution host computing device with the cluster. In some embodiments, the transaction execution manager may associate the transaction execution host computing devices with a cluster by adding the designation to an internal look-up table. The number of transaction execution host computing devices the transaction execution manager associates with the cluster may be determined based on a maximum allowed number of query processors per cluster for each transaction execution host computing device and the number of requested connections. For example, the number of transaction execution host computing devices the transaction execution manager associates with the cluster may be the number of requested connections divided by the maximum allowed number of query processors per cluster for each transaction execution host computing device.

At 404, the transaction execution manager receives a request to process a transaction for a database associated with the database cluster. At 502, the transaction execution manager selects a transaction execution host computing device to process the transaction. The transaction execution manager may select a transaction execution host computing device from a set of transaction execution host computing devices which are associated with the cluster. The transaction execution manager may select the transaction execution host computing device randomly, using a round robin method, based on transaction execution host computing device workload, or using another selection method. As an example, the transaction execution manager may select a transaction execution host computing device which is not currently operating at capacity, or which is not currently executing a maximum allowed number of transactions for the particular cluster.

At 504, the transaction execution manager determines whether there is a processor allocator associated with the database cluster at the selected transaction execution host computing device. If the transaction execution manager determines there is a processor allocator associated with the database cluster at the selected transaction execution host computing device, at 506 the transaction execution manager sends the transaction to the processor allocator. If the transaction execution manager determines there is not a processor allocator associated with the database cluster at the transaction execution host computing device, at 508 the transaction execution manager associates a processor allocator with the database cluster and sends the transaction to the newly associated processor allocator.

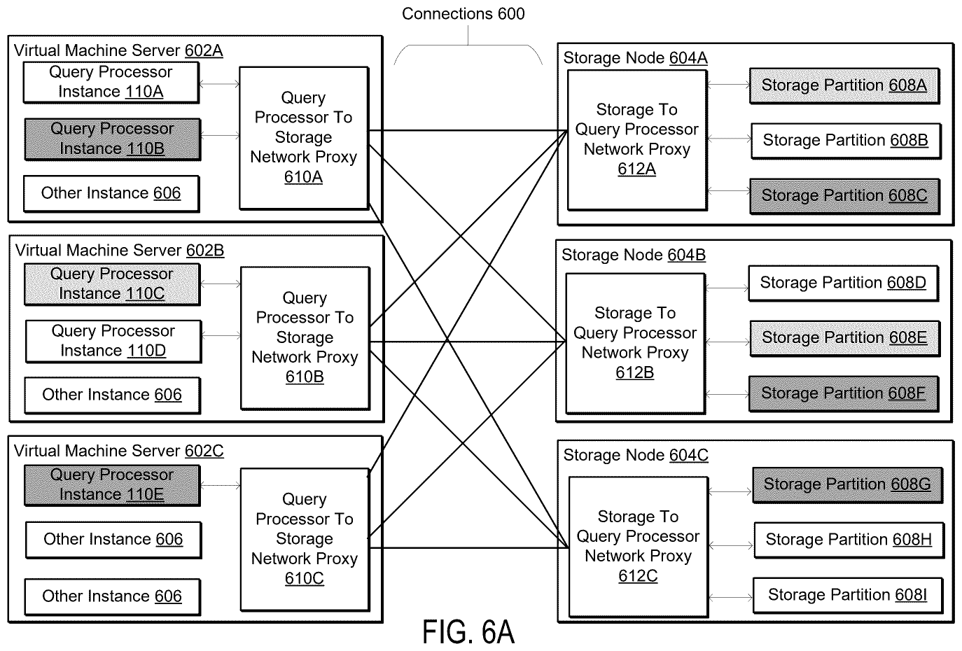

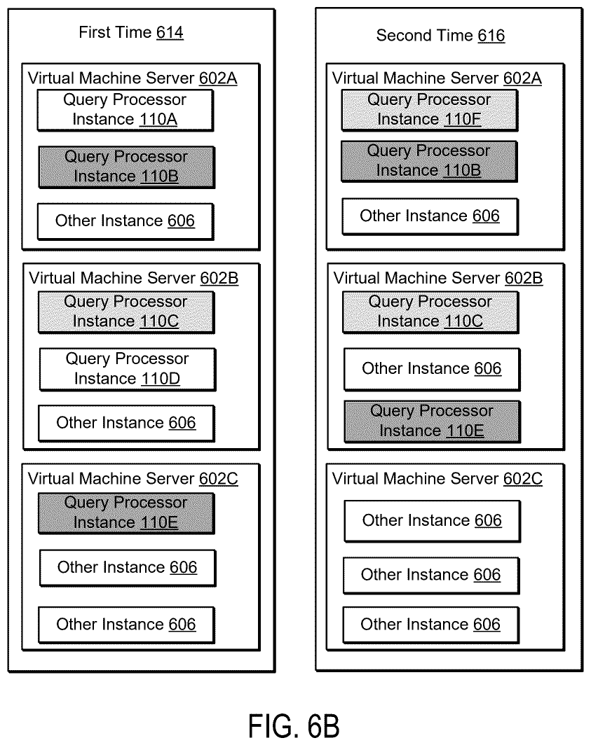

FIG. 6A is a block diagram illustrating a query processor to storage network arranged as a complete bipartite graph (e.g., biclique), according to some embodiments.

Connections 600, query processor to storage network proxies 610, and storage to query processor network proxies 612 may comprise a connection layer which enables query processor instances 110 to maintain indirect connections to any storage partitions 608 the query processor instances 110 communicate with, for example, storage partitions 608 of the same cluster as a query processor instance 110. Each illustrated query processor to storage network proxy 610 is connected, via a connection 600, to each storage to query processor network proxy 612. Query processor instances 110 are connected to a query processor to storage network proxy 610 of the query processor instances' 110 respective virtual machine servers 602. A virtual machine server 602 may be a transaction execution host computing device, for example. Storage partitions 608 are connected to the storage to query processor network proxy 612 of the storage partitions' 608 respective storage nodes 604. For each of query processor instances 110A-E, there is a connection path to each of storage partitions 608A-I that does not require the query processor 110 to maintain memory space dedicated to each storage partition 608. Any given query processor instance 110, with correct permissions, is able to connect to any given storage partition 608 to execute a transaction request. In some embodiments, connections 600 between network proxies that are not in use may be terminated.

Query processor instances 110 and storage partitions 608 may correspond to particular clusters. As an example, the color of the individual components may indicate color, as an example, query processor instance 110B and query processor instance 110E may correspond to a dark grey cluster with storage partition 608C, storage partition 608F, and storage partition 608G. Individual components of a first cluster may share permissions to interact with data for the first cluster, and individual components of a different cluster may not have permission to interact with data for the first cluster. Network proxies may be generic to clusters, for example, storage to query processor network proxy 612A may handle and distribute incoming transaction requests for the white, light grey, and dark grey clusters and return data responsive to the transaction requests for all clusters. Data passing through the connection layer of the proxies and connections 600 may be encrypted, for example by using a token that is shared by other components of the cluster. The query processor instances 110 and storage partitions 608 of a cluster may use a token that is specific to the cluster to encrypt and decrypt data being sent from one component to another.

The proxies may combine data packets which are to be sent along a single connection 600. For example, query processor to storage network proxy 610A may combine transaction requests from query processor instance 110A and query processor 110B that are directed to storage partition 608D and storage partition 608F respectively into a combined data packet. Storage partition 608D and storage partition 608F are both connected to storage to query processor network proxy 612B. Storage to query processor network proxy 612B may receive a combined data packet from query processor to storage network proxy 610A containing the transaction requests from query processor instance 110A and query processor 110B, divide the combined data packet into the transaction requests, and deliver the transaction requests to storage partition 608D and storage partition 608F respectively.

The proxies may also combine health information and key range requests. The query processor to storage network proxies 610 may maintain health information and key range information about each of the storage partitions 608. Instead of sending an individual request directed to each storage partition 608, query processor to storage network proxy 610A may send three combined packets requesting health and key range information, one to each of storage to query processor network proxy 612A, storage to query processor network proxy 612B, and storage to query processor network proxy 612C. The storage to query processor network proxies 612 may divide the combined packets and send them to the connected storage partitions 608. The storage to query processor network proxies 612 may similarly combine the returning information from the storage partitions 608. In some embodiments, a distribution plane may maintain and provide key range information and the locations of particular storage partitions 608. In some embodiments, a control plane may monitor health information of storage partitions 608 for significant events, such as a crash at a storage node 604.

The query processor to storage network proxies 610 may use the health information to know which storage partitions 608 contain the most recently updated data, and may use the key range information to know which storage partitions 608 contain data responsive to particular queries. The query processor to storage network proxies 610 may determine the target destination of requests from the query processor instances 110 based on the health information and key range information.

FIG. 6B is a block diagram illustrating virtual machine servers that implement query processors of a distributed database at a first time, such as before a cluster closes the query processor instances of the cluster, and also illustrating the virtual machine servers at a second time, such as after the cluster closes the query processor instances of the cluster, according to some embodiments.

At the first time 614, query processor instances 110 may be instantiated in a particular configuration, as illustrated in FIG. 9. The configuration of query processor instances 110 may change so that query processor instances 110 are instantiated differently at a second time 616. For example, between the first time 614, and the second time 616, the white cluster stopped operation of the white cluster's query processor instances 110, including specifically query processor instance 110A and query processor instance 110D. The client associated with the white cluster may have finished updating and using the distributed database between first time 614 and second time 616 and the virtual machine servers 602 may have stopped maintaining an idle pool of query processor instances for the white cluster.

Query processor instance 110A disconnected from the network proxy associated with virtual machine server 602A and closed, i.e., the memory associated with query processor instance 110A was released. The virtual machine hosting query processor instance 110A replaced query processor instance 110A with a new query processor instance 110F. Query processor instance 110F is associated with light grey cluster. Light grey cluster may have added query processor instance 110F in response to an increase in the number of transaction requests for the light grey cluster. Query processor instance 110F, when instantiated on the virtual machine, connected to the network proxy associated with virtual machine server 602A. Query processor instance 110D disconnected from the network proxy associated with virtual machine server 602B and closed. The virtual machine hosting query processor instance 110D was replaced with an other instance 606 not related to the distributed database. Other instance 606 did not connect to the network proxy associated with virtual machine server 602B when instantiated.

Query processor instance 110E moved from a virtual machine on virtual machine server 602C to a virtual machine on virtual machine server 602B. Query processor instance 110E disconnected from the network proxy associated with virtual machine server 602C and closed, and was instantiated on virtual machine server 602B. Query processor instance 110E connected to the network proxy associated with virtual machine server 602B and resumed operation. A distribution plane of the distributed database may have informed the proxies of the distributed database of the change. Virtual machine server 602C at the second time 616 may be unassociated with the distributed database system or may begin implementing another type of component of the distributed database system, for example adjudicator instances or management instances.

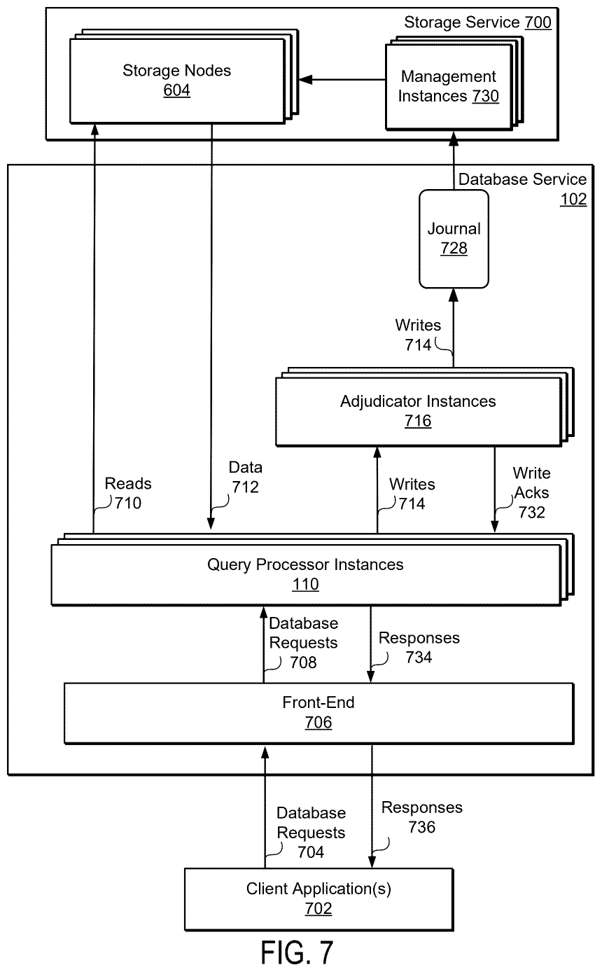

FIG. 7 is a block diagram illustrating various components of a database service and storage service that host a distributed database, according to some embodiments.

One or more client application(s) 702 may store data to one or more databases maintained by a database service 102. Client application(s) 702 may submit database requests 704 (e.g., requests that cause reads, such as queries or read-only transactions, or requests that cause writes, such as updates, inserts, deletions, or transactions that include write statements) and receive responses 736 from front-end 706.

Front-end 706 may dispatch database requests 708 to a query processor instance 110, which may parse the request and interact with different components according to the type of request. For read requests, query processor instance 110 may rely upon a local cache and/or access storage nodes 604 by submitting read requests 710 for data, which are returned as data 712 and used to respond to the read. For writes, write requests 714 may be sent to an adjudicator instance 716, which may determine whether a conflict exists and if not, writes 714 to journal 728 and acknowledges the write 732 to query processor instance 110. Responses 734 may then be sent to front-end 706 for response 736 to client application(s) 702. Transactions may be applied to the database by management instance 730, at a time independent of the write acknowledgement 732, responses 734, and responses 736.

Database service 102 may implement a fleet of host computing devices which may provide, in various embodiments, a multi-tenant configuration so that different query processor instances, such as query processor instance 110 and other query processors, can be hosted on the same virtual machine, but provide access to different databases on behalf of different clients over different connections. In some embodiments, hosts systems may not be multi-tenant and a single virtual machine may implement a single query processor instance 110 which may provide access to a single database for a single client.

In some embodiments, database data for a database of database service 102 may be stored in a separate storage service 700. In some embodiments, storage service 700 may be implemented to store database data as virtual disk or other persistent storage drives. In some embodiments, embodiments, storage service 700 may store data for databases using tree structured storage and log structured storage.

For example, data may be organized in various logical volumes, segments, and pages for storage on one or more storage nodes 604 of storage service 700. For example, in some embodiments, each database may be represented by a logical volume, and each logical volume may be segmented into storage partitions over a collection of storage nodes 604. A storage partition may be an individual component that an individual query processor instance 110, for example, may communicate with. Each storage partition, which may be hosted on a particular one of the storage nodes, may contain a set of contiguous block addresses, in some embodiments.

In at least some embodiments, storage nodes 604 may provide multi-tenant storage so that data stored in a storage partition of one storage device may be stored for a different database, database user, account, or entity than data stored in another storage partition on the same storage device (or other storage devices) of the same storage node 604. Various access controls and security mechanisms may be implemented, in some embodiments, to ensure that data is not accessed at a storage node 604 except for authorized requests (e.g., for users authorized to access the database, owners of the database, etc.). For example, a cluster of database components may correspond to a particular database, and may use tokens specific to the cluster to identify and encrypt data.

In some embodiments, each storage partition may store a collection of one or more data pages and a change log (also referred to as a redo log) (e.g., a log of redo log records) for each data page that it stores. Storage nodes 604 may receive redo log records and coalesce them to create new versions of the corresponding data and/or additional or replacement log records (e.g., lazily and/or in response to a request for data or a database crash). In some embodiments, data and/or change logs may be mirrored across multiple storage nodes 604, according to a variable configuration (which may be specified by the client on whose behalf the database is being maintained in the database system). For example, in different embodiments, one, two, or three copies of the data or change logs may be stored in each of one, two, or three different availability zones or regions, according to a default configuration, an application-specific durability preference, or a client-specified durability preference.

In some embodiments, a volume may be a logical concept representing a highly durable unit of storage that a user/client/application of the storage system understands. A volume may be a distributed store that appears to the user/client/application as a single consistent ordered log of write operations to various user pages of a database, in some embodiments. Each write operation may be encoded in a log record (e.g., a redo log record), which may represent a logical, ordered mutation to the contents of a single user page within the volume, in some embodiments. Each log record may include a unique identifier (e.g., a Logical Sequence Number (LSN)), in some embodiments. Each log record may be persisted to one or more synchronous segments in the distributed store that form a Protection Group (PG), to provide high durability and availability for the log record, in some embodiments. A volume may provide an LSN-type read/write interface for a variable-size contiguous range of bytes, in some embodiments.

In some embodiments, journal 728, which may be a logical journal, may be hosted in database service 102 that stores ordered updates to the database (e.g., to a database volume). Adjudicator instances 716 may be responsible for deciding whether transactions or writes can be committed (while following isolation rules), for working with database journal 728 to order transactions, and for ensuring that committed data is consistent. Management instances 730, which may be a logical crossbar server, may apply updates to the database stored at the storage nodes 604 from the database journal 728 as directed by the adjudicator instances 716.

Front-end 706 may implement a proxy, request router, or other load balancing feature that routes database requests to one or more query processor instances 110. For example, front-end 706 may be responsible for authenticating requests to connect to a database at a particular network endpoint and allocating a query processor instance 110 to the connection (or to a particular request such as a read or a write). The front-end 706 may maintain the connection (e.g., as a proxy) so that if different query processor instances 110 are used for different requests to the database, separate connections do not have to be established.

Database service 102 may implement a control plane which may manage the creation, provisioning, deletion, or other features of managing a database hosted in database service 102. For example, the control plane may monitor the performance of host computing devices (e.g., a computing system or device like computing system 900 discussed below with regard to FIG. 9) for high workloads (e.g., heat) and move or redirect placement of database engine head node instances away from some host computing devices to avoid overburdening host computing devices. The control plane may handle various management requests, such as requests to create databases or manage databases (e.g., by configuring or modifying performance), such as by enabling a “serverless” or other automated management feature in response to a request which may cause in-place resource scaling to be enabled for that database. The control plane may direct placement of database engine head node instances on host computing devices so as to distribute workload across host computing devices to avoid failure scenarios, like out-of-memory.

Database service 102 may implement one or more different types of database systems with respective query processor instances 110 for accessing database data as part of the database. For example, database service 102 may implement various types of connection-based (e.g., having established a network connection between a database client and query processor instances 110 on a database host system) database systems which may, for instance, facilitate the performance of various operations that continue over multiple communications between the database client and the connected query processor instance 110. In at least some embodiments, database service 102 may be a relational database service that hosts relational databases on behalf of clients.

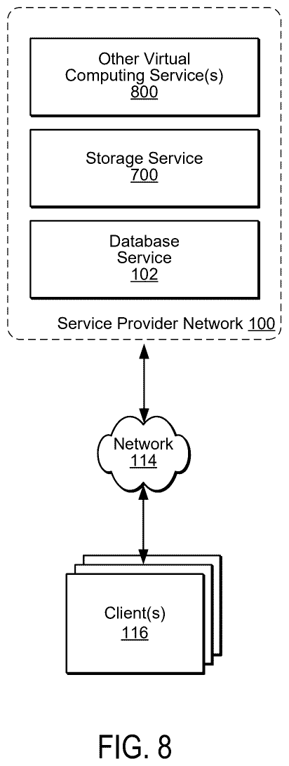

FIG. 8 is a block diagram illustrating a provider network that may implement database services that implement techniques described herein, according to some embodiments.

A service provider network 100 (sometimes referred to as a “cloud provider network” or “cloud”) refers to a pool of network-accessible computing resources (such as compute, storage, and networking resources, applications, and services), which may be virtualized or bare-metal. The service provider network 100 can provide convenient, on-demand network access to a shared pool of configurable computing resources that can be programmatically provisioned and released in response to user commands. These resources can be dynamically provisioned and reconfigured to adjust to variable load. Cloud computing can thus be considered as both the applications delivered as services over a publicly accessible network 114 (e.g., the Internet, a cellular communication network) and the hardware and software in cloud provider data centers that provide those services.

A service provider network 100 can be formed as a number of regions, where a region is a separate geographical area in which the cloud provider clusters data centers. Each region can include two or more availability zones connected to one another via a private high-speed network, for example, a fiber communication connection. An availability zone (also known as an availability domain, or simply a “zone”) refers to an isolated failure domain including one or more data center facilities with separate power, separate networking, and separate cooling from those in another availability zone. A data center refers to a physical building or enclosure that houses and provides power and cooling to servers of the cloud provider network. Preferably, availability zones within a region are positioned far enough away from one other that the same natural disaster should not take more than one availability zone offline at the same time. Users can connect to availability zones of the provider network via a publicly accessible network (e.g., the Internet, a cellular communication network) by way of a transit center (TC). TCs can be considered as the primary backbone locations linking users to the provider network, and may be collocated at other network provider facilities (e.g., Internet service providers, telecommunications providers) and securely connected (e.g. via a VPN or direct connection) to the availability zones. Each region can operate two or more TCs for redundancy. Regions are connected to a global network connecting each region to at least one other region. The provider network may deliver content from points of presence outside of, but networked with, these regions by way of edge locations and regional edge cache servers (points of presence, or PoPs). This compartmentalization and geographic distribution of computing hardware enables the provider network to provide low-latency resource access to users on a global scale with a high degree of fault tolerance and stability.

The provider network may implement various computing resources or services, which may include a virtual compute service, data processing service(s) (e.g., map reduce, data flow, and/or other large scale data processing techniques), data storage services (e.g., object storage services, block-based storage services, or data warehouse storage services) and/or any other type of network based services (which may include various other types of storage, processing, analysis, communication, event handling, visualization, and security services not illustrated). The resources required to support the operations of such services (e.g., compute and storage resources) may be provisioned in an account associated with the cloud provider, in contrast to resources requested by users of the provider network, which may be provisioned in user accounts.

The traffic and operations of the provider network may broadly be subdivided into two categories in various embodiments: control plane operations carried over a logical control plane and data plane operations carried over a logical data plane. While the data plane represents the movement of user data through the distributed computing system, the control plane represents the movement of control signals through the distributed computing system. The control plane generally includes one or more control plane components distributed across and implemented by one or more control servers. Control plane traffic generally includes administrative operations, such as system configuration and management (e.g., resource placement, hardware capacity management, diagnostic monitoring, system state information). The data plane includes customer resources that are implemented on the cloud provider network (e.g., computing instances, containers, block storage volumes, databases, file storage). Data plane traffic generally includes non-administrative operations such as transferring customer data to and from the customer resources. Certain control plane components (e.g., tier one control plane components such as the control plane for a virtualized computing service) are typically implemented on a separate set of servers from the data plane servers, while other control plane components (e.g., tier two control plane components such as analytics services) may share the virtualized servers with the data plane, and control plane traffic and data plane traffic may be sent over separate/distinct networks.

An exemplary provider network may include numerous provider network regions and so on that may include one or more data centers hosting various resource pools, such as collections of physical and/or virtualized computer servers, storage devices, networking equipment and the like (e.g., computing system 900 described below with regard to FIG. 9), needed to implement and distribute the infrastructure and storage services offered by the provider network within the provider network regions.

As illustrated in FIG. 8, a number of clients (shown as clients 116) may interact with a service provider network 100 via a network 114. Service provider network 100 may implement respective instantiations of the same (or different) services, such as a database service 102 for a first region and a second instantiation of database service 102 for a second region, and so on. Similar arrangements may be implemented for storage service 700, as well as various other virtual computing services 800. It is noted that where one or more instances of a given component may exist, reference to that component herein may be made in either the singular or the plural. However, usage of either form is not intended to preclude the other.

In various embodiments, the components illustrated in FIG. 8 may be implemented directly within computer hardware, as instructions directly or indirectly executable by computer hardware (e.g., a microprocessor or computer system), or using a combination of these techniques. For example, the components of FIG. 8 may be implemented by a system that includes a number of computing nodes (or simply, nodes), each of which may be similar to the computer system embodiment illustrated in FIG. 9 and described below. In various embodiments, the functionality of a given service system component (e.g., a component of the database service or a component of the storage service) may be implemented by a particular node or may be distributed across several nodes. In some embodiments, a given node may implement the functionality of more than one service system component (e.g., more than one database service system component).

Generally speaking, clients 116 may encompass any type of client configurable to submit network-based services requests to service provider network 100 via network 114, including requests for database services. For example, a given client 116 may include a suitable version of a web browser, or may include a plug-in module or other type of code module that may execute as an extension to or within an execution environment provided by a web browser. Alternatively, a client 116 (e.g., a database service client) may encompass an application such as a database application (or user interface thereof), a media application, an office application or any other application that may make use of persistent storage resources to store and/or access one or more database tables. In some embodiments, such an application may include sufficient protocol support (e.g., for a suitable version of Hypertext Transfer Protocol (HTTP)) for generating and processing network-based services requests without necessarily implementing full browser support for all types of network-based data. That is, client 116 may be an application which may interact directly with service of a region of a provider network. In some embodiments, client 116 may generate network-based services requests according to a Representational State Transfer (REST)-style web services architecture, a document-based or message-based network-based services architecture, or another suitable network-based services architecture. Although not illustrated, some clients of service provider network 100 services may be implemented within a service of the provider network (e.g., a client application of database service 102 may be implemented on one of other virtual computing service(s) 800), in some embodiments. Therefore, various examples of the interactions discussed with regard to clients 116 may be implemented for internal clients as well, in some embodiments.

In some embodiments, a client 116 (e.g., a database service client) may be provided access to network-based storage of database data to other applications in a manner that is transparent to those applications. For example, client 116 may be integrated with an operating system or file system to provide storage in accordance with a suitable variant of the storage models described herein. However, the operating system or file system may present a different storage interface to applications, such as a conventional file system hierarchy of files, directories, and/or folders. In such an embodiment, applications may not need to be modified to make use of the storage system service model, as described above. Instead, the details of interfacing to the provider network may be coordinated by client 116 and the operating system or file system on behalf of applications executing within the operating system environment.

Clients 116 may convey network-based services requests to and receive responses from a region of the provider network via network 114. In various embodiments, network 114 may encompass any suitable combination of networking hardware and protocols necessary to establish network-based communications between clients 116 and a service provider network 100. For example, network 114 may generally encompass the various telecommunications networks and service providers that collectively implement the Internet. Network 114 may also include private networks such as local area networks (LANs) or wide area networks (WANs) as well as public or private wireless networks. For example, both a given client 116 and the provider network region may be respectively provisioned within enterprises having their own internal networks. In such an embodiment, network 114 may include the hardware (e.g., modems, routers, switches, load balancers, proxy servers, etc.) and software (e.g., protocol stacks, accounting software, firewall/security software, etc.) necessary to establish a networking link between given client 116 and the Internet as well as between the Internet and a provider network. It is noted that in some embodiments, clients 116 may communicate with regions of a provider network using a private network rather than the public Internet. For example, clients 116 may be provisioned within the same enterprise as a database service. In such a case, clients 116 may communicate with a provider network region entirely through a private network 114 (e.g., a LAN or WAN that may use Internet-based communication protocols but which is not publicly accessible).

Generally speaking, service provider network 100 may implement one or more service endpoints which may receive and process network-based services requests, such as requests to access a database (e.g., queries, inserts, updates, etc.) and/or manage a database (e.g., create a database, configure a database, etc.). For example, a provider network region may include hardware and/or software which may implement a particular endpoint, such that an HTTP-based network-based services request directed to that endpoint is properly received and processed. In one embodiment, a provider network region may be implemented as a server system may receive network-based services requests from clients 116 and to forward them to components of a system that implements database service 102, storage service 700, and/or another virtual computing service 800 for processing. In other embodiments, provider network region may be configured as a number of distinct systems (e.g., in a cluster topology) implementing load balancing and other request management features may dynamically manage large-scale network-based services request processing loads. In various embodiments, a provider network region may support REST-style or document-based (e.g., SOAP-based) types of network-based services requests.

In addition to functioning as an addressable endpoint for clients' network-based services requests, in some embodiments, a service provider network 100 may implement various client management features. For example, service provider network 100 may coordinate the metering and accounting of client usage of network-based services, including storage resources, such as by tracking the identities of requesting clients 116, the number and/or frequency of client requests, the size of data tables (or records thereof) stored or retrieved on behalf of clients 116, overall storage bandwidth used by clients 116, class of storage requested by clients 116, or any other measurable client usage parameter. Provider network regions may also implement financial accounting and billing systems, or may maintain a database of usage data that may be queried and processed by external systems for reporting and billing of client usage activity. In certain embodiments, provider network regions may collect, monitor and/or aggregate a variety of storage service system operational metrics, such as metrics reflecting the rates and types of requests received from clients 116, bandwidth utilized by such requests, system processing latency for such requests, system component utilization, such as the target capacity determined for individual database engine head node instances, network bandwidth and/or storage utilization, rates and types of errors resulting from requests, characteristics of storage and databases (e.g., size, data type, etc.), or any other suitable metrics. In some embodiments, such metrics may be used by system administrators to tune and maintain system components, while in other embodiments such metrics (or relevant portions of such metrics) may be exposed to clients 116 to enable such clients to monitor their usage of database service 102, storage service 700 and/or another virtual computing service 800 (or the underlying systems that implement those services).

In some embodiments, provider network regions may also implement user authentication and access control procedures. For example, for a given network-based services request to access a particular database table, a provider network region may ascertain whether the client 116 associated with the request is authorized to access the particular database table. Provider network regions may determine such authorization by, for example, evaluating an identity, password or other credential against credentials associated with the particular database table, or evaluating the requested access to the particular database table against an access control list for the particular database table. For example, if a client 116 does not have sufficient credentials to access the particular database table, the provider network region may reject the corresponding network-based services request, for example by returning a response to the requesting client 116 indicating an error condition. Various access control policies may be stored as records or lists of access control information by database services 102, storage services 700, and/or other virtual computing services 800.

Note that in many of the examples described herein, services, like database service 102 or storage service 700 may be internal to a computing system or an enterprise system that provides database services to clients 116, and may not be exposed to external clients (e.g., users or client applications). In such embodiments, the internal “client” (e.g., database service 102) may access storage service 700 over a local or private network (e.g., through an API directly between the systems that implement these services). In such embodiments, the use of storage service 700 in storing database storage structures on behalf of clients 116 may be transparent to those clients. In other embodiments, storage service 700 may be exposed to clients 116 through service provider network 100 to provide storage of database tables or other information for applications other than those that rely on database service 102 for database management. In such embodiments, clients of the storage service 700 may access storage service 700 via network 114 (e.g., over the Internet). In some embodiments, a virtual computing service 800 may receive or use data from storage service 700 (e.g., through an API directly between the virtual computing service 800 and storage service 700) to store objects used in performing computing services 800 on behalf of a client 116. In some cases, the accounting and/or credentialing services of provider network region may be unnecessary for internal clients such as administrative clients or between service components within the same enterprise.

### Example Computer System

FIG. 9 is a block diagram illustrating an example computer system that implements some or all of the techniques described herein, according to some embodiments.

FIG. 9 illustrates exemplary computer system 900 usable to implement the processor allocator as described above with reference to FIGS. 1-8. In different embodiments, computer system 900 may be any of various types of devices, including, but not limited to, a network computer, a mobile device, a consumer device, application server, storage device, a peripheral device such as a switch, modem, router, or in general any type of computing or electronic device.

Various embodiments of program instructions for a processor allocator 930, as described herein, may be executed in one or more computer systems 900, which may interact with various other devices. Note that any component, action, or functionality described above with respect to FIGS. 1-8 may be implemented on one or more computers configured as computer system 900 of FIG. 9, according to various embodiments. In the illustrated embodiment, computer system 900 includes one or more processors 910 coupled to a system memory 920 via an input/output (I/O) interface 940. Computer system 900 further includes a network interface 950 coupled to I/O interface 940, and one or more input/output devices 960. In some cases, it is contemplated that embodiments may be implemented using a single instance of computer system 900, while in other embodiments multiple such computer systems, or multiple nodes making up computer system 900, may be configured to host different portions or instances program instructions as described above for various embodiments. For example, in one embodiment some elements of the program instructions may be implemented via one or more nodes of computer system 900 that are distinct from those nodes implementing other elements.

In some embodiments, computer system 900 may be implemented as a system on a chip (SoC). For example, in some embodiments, processors 910, memory 920, I/O interface 940 (e.g., a fabric), etc. may be implemented in a single SoC comprising multiple components integrated into a single chip. For example, a SoC may include multiple CPU cores, a multi-core GPU, a multi-core neural engine, cache, one or more memories, etc. integrated into a single chip. In some embodiments, an SoC embodiment may implement a reduced instruction set computing (RISC) architecture, or any other suitable architecture.

System memory 920 may be configured to store compression or decompression program instructions for a processor allocator 930 accessible by one or more of the processors 910. In various embodiments, system memory 920 may be implemented using any suitable memory technology, such as static random-access memory (SRAM), synchronous dynamic RAM (SDRAM), nonvolatile/Flash-type memory, or any other type of memory. In the illustrated embodiment, program instructions for a processor allocator 930 may be configured to implement any of the functionality described above. In some embodiments, program instructions and/or data may be received, sent, or stored upon different types of computer-accessible media or on similar media separate from system memory 920 or computer system 900.

In one embodiment, I/O interface 940 may be configured to coordinate I/O traffic between processor 910, system memory 920, and any peripheral devices in the device, including network interface 950 or other peripheral interfaces, such as input/output devices 960. In some embodiments, I/O interface 940 may perform any necessary protocol, timing, or other data transformations to convert data signals from one component (e.g., system memory 920) into a format suitable for use by another component (e.g., processor 910). In some embodiments, I/O interface 940 may include support for devices attached through various types of peripheral buses, such as a variant of the Peripheral Component Interconnect (PCI) bus standard or the Universal Serial Bus (USB) standard, for example. In some embodiments, the function of I/O interface 940 may be split into two or more separate components, such as a north bridge and a south bridge, for example. Also, in some embodiments, some or all of the functionality of I/O interface 940, such as an interface to system memory 920, may be incorporated directly into processor 910.

Network interface 950 may be configured to allow data to be exchanged between computer system 900 and other devices attached to a network 970 (e.g., carrier or agent devices) or between nodes of computer system 900. Network 970 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 950 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 960 may, in some embodiments, include one or more display terminals, keyboards, keypads, touchpads, scanning devices, voice or optical recognition devices, or any other devices suitable for entering or accessing data by one or more computer systems 900. Multiple input/output devices 960 may be present in computer system 900 or may be distributed on various nodes of computer system 900. In some embodiments, similar input/output devices may be separate from computer system 900 and may interact with one or more nodes of computer system 900 through a wired or wireless connection, such as over network interface 950.

As shown in FIG. 9, memory 920 may include program instructions for a processor allocator 930, which may be processor-executable to implement any element or action described above. In one embodiment, the program instructions may implement the methods described above. In other embodiments, different elements and data may be included.

Computer system 900 may also be connected to other devices that are not illustrated, or instead may operate as a stand-alone system. In addition, the functionality provided by the illustrated components may in some embodiments, be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 900 may be transmitted to computer system 900 via transmission media or signals such as electrical, electromagnetic, or digital signals, conveyed via a communication medium such as a network and/or a wireless link. Various embodiments may further include receiving, sending, or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A system, comprising:
a transaction execution manager of a database service; and
a set of transaction execution host computing devices, each further comprising:
a set of query processors configurable to process transactions; and
a set of query processor allocators;
wherein:
the transaction execution manager is configured to distribute, to the set of transaction execution host computing devices, a number of connections to be associated with a cluster;
another number of query processors, which is different from the number of connections, is associated with the cluster;
a processor allocator of a given one of the transaction execution host computing devices is associated with the cluster, wherein the processor allocator is configured to accept a portion of the distributed number of connections to be associated with the cluster;
the processor allocator is configured to receive a transaction associated with the cluster and select a query processor to execute the transaction;
the query processor is associated with the cluster based on being previously selected to process another transaction associated with the cluster or based on being selected to process the transaction.

2. The system of claim 1, wherein:
the query processor, after processing the transaction, is configured to remain associated with the cluster until a release event for releasing the query processor occurs.

3. The system of claim 2, wherein the query processor is configured to remain associated with the cluster while the query processor is configured to process transactions for the cluster.

4. The system of claim 1, wherein the allocator is configured to store some state information related to the query processor.

5. The method of claim 1, wherein the transaction is a read or a write for a database, which is associated with the cluster, of the database service.

6. A method, comprising:
accepting, at a computing device for a database service, a number of connections to be associated with a cluster, wherein another number of query processors, which is different than the number of accepted connections, are associated with the cluster;
receiving, via a given one of the accepted number of connections, a transaction to be executed, wherein the transaction is associated with the cluster;
selecting, via an allocator associated with the cluster, a query processor to execute the transaction, wherein the selected processor is associated with the cluster and wherein a number of query processors associated with the cluster is equal to or fewer than the number of requested connections.

7. The method of claim 6, wherein:
the query processor, after processing the transaction, remains associated with the cluster until a release event releasing the query processor occurs.

8. The method of claim 7, wherein the query processor remains associated with the cluster while the query processor is configured to process transactions for the cluster.

9. The method of claim 6, further comprising:
maintaining a set of query processors, which are available to the allocator, and which are configured to process transactions and are available to be adapted to process transactions for the cluster.

10. The method of claim 6, wherein the allocator is associated with a given host computing device of a set of host computing devices, further comprising:
associating the given host computing device to the cluster in response to said accepting the number of connections.

11. The method of claim 10, wherein a given connection can be reassigned to another host computing device.

12. The method of claim 6, wherein the transaction is a read or a write for a database, which is associated with the cluster, of the database service.

13. The method of claim 6, wherein the allocator maintains some state information related to the query processor.

14. A non-transitory computer-readable storage medium storing program instructions that, when executed on or across one or more processors, cause the one or more processors to:
accept, at a computing device for a database service, a number of connections to be associated with a cluster, wherein another number of query processors, which is different than the number of accepted connections, are associated with the cluster;
receive, via a given one of the accepted number of connections, a transaction to be executed, wherein the transaction is associated with the cluster;
select, via an allocator associated with the cluster, a query processor to execute the transaction, wherein the selected processor is associated with the cluster and wherein a number of query processors associated with the cluster is equal to or fewer than the number of requested connections.

15. The computer-readable storage media of claim 14, wherein:
the query processor, after processing the transaction, remains associated with the cluster until a release event for releasing the query processor occurs.

16. The computer-readable storage media of claim 15, wherein the query processor remains associated with the cluster while the query processor is configured to process transactions for the cluster.

17. The computer-readable storage media of claim 14, wherein the program instructions, when executed on or across the one or more processors, further cause the one or more processors to:
maintain a set of query processors, which are available to the allocator, and which are configured to process transactions and are available to be adapted to process transactions for the cluster.

18. The computer-readable storage media of claim 14, wherein:
the processor allocator is associated with a given host computing device of a set of host computing devices; and
the program instructions, when executed on or across the one or more processors, further cause the one or more processors to associate the given host computing device with the cluster in response to said accepting the number of connections.

19. The computer-readable storage media of claim 14, wherein the transaction is a read or a write for a database, which is associated with the cluster, of the database service.

20. The computer-readable storage media of claim 14, wherein the allocator maintains some state information related to the query processor.
